(19) United States
(12) Patent Application Publication
(10) Pub. No.: US 2012/0081352 A1
(43) Pub. Date: Apr. 5, 2012

(54) DISPLAY DEVICE

(75) Inventor: Yasuhiko YAMAGISHI, Mobara (JP)

(73) Assignees: Panasonic Liquid Crystal Display Co., Ltd.; Hitachi Displays, Ltd.

(21) Appl. No.: 13/247,041

(22) Filed: Sep. 28, 2011

(30) Foreign Application Priority Data
Sep. 30, 2010 (JP) 2010-221070

(51) Int. Cl. G09G 3/36; G09G 5/10; G06F 3/038

(52) U.S. Cl. 345/212; 345/690; 345/98

(57) ABSTRACT

Potential fluctuation of a common voltage is canceled, and greenish coloring of a screen displayed on a liquid crystal display panel is reduced to provide a high-quality image. A liquid crystal display device includes a liquid crystal display panel having plural pixels in which each of the pixels includes a pixel electrode and a counter electrode. The liquid crystal display device includes a detector circuit that detects a specific image pattern that induces a potential fluctuation of a common voltage applied to the counter electrode, and a VCOM generator circuit that generates the common voltage to be applied to the counter electrode. The VCOM generator circuit applies the common voltage in which an inverse compensation voltage that compensates the potential fluctuation is superimposed on a reference common voltage to the counter electrode on the basis of a detection result of the detector circuit.

### CROSS-REFERENCE TO RELATED APPLICATION

The present application claims priority from Japanese patent application JP 2010-221070 filed on Sep. 30, 2010, the content of which is hereby incorporated by reference into this application.

### BACKGROUND OF THE INVENTION

1. Field of the Invention

The present invention relates to a liquid crystal display device, and more particularly to a liquid crystal display device employing a common symmetry method such as a dot inversion method as a driving method.

2. Description of the Related Art

TFT liquid crystal display devices using thin-film transistors as active elements can display high-definition images, and therefore have been frequently used as display devices such as TV sets and displays for personal computers.

The liquid crystal display device basically includes a so-called liquid crystal display panel in which a liquid crystal layer is held between two (a pair of) substrates at least one of which is made of transparent glass or the like. The liquid crystal display device selectively applies a voltage to various electrodes for pixel formation which are formed on the substrate of the liquid crystal display panel to brighten and darken a given pixel. The liquid crystal display device thus configured is excellent in contrast performance and fast display performance.

When a constant voltage (DC voltage) is applied to the liquid crystal layer for a long time, the inclination of the liquid crystal layer is fixed, as a result of which a residual image phenomenon is induced to shorten the lifetime of the liquid crystal layer. In order to prevent this drawback, in the liquid crystal display device, the voltage to be applied to the liquid crystal layer is made alternating every given time, that is, a voltage to be applied to each pixel electrode is changed to a positive voltage side and a negative voltage side with reference to a common voltage (VCOM) to be applied to a counter electrode every given time.

JP 2009-15334A discloses two methods of a common symmetry method and a common inversion method as a driving method for applying an AC voltage to the liquid crystal layer.

In the common symmetry method, the common voltage (VCOM) to be applied to the counter electrode is kept constant, and a voltage (that is, a gradation voltage) to be applied to the pixel electrode is reversed to a voltage higher in potential than the common voltage (VCOM) or a voltage lower in potential than the common voltage (VCOM). This method has been known as a dot inversion method, or an n-line (for example, 2 lines) inversion method.

### SUMMARY OF THE INVENTION

FIG. 9 is a diagram illustrating the drive polarities of pixels in the dot inversion method of the liquid crystal display device.

In the dot inversion method, when attention is paid to adjacent pixels, for example, DR0(+) and DG0(−) of a line G0, the polarity of those pixels is plus (+) and minus (−), and in subsequent pixels, the pixels are driven so that the adjacent pixels are reverse in the polarity. In this example, the plus (+) means that a gradation voltage higher than the potential of the counter electrode is applied to the pixel electrode at the time of writing the gradation voltage into the pixel. The minus (−) means that a gradation voltage lower than the potential of the counter electrode is applied to the pixel electrode at the time of writing the gradation voltage into the pixel.

In a subsequent frame, the polarity of the pixels is reverse to the polarity in the previous frame. That is, the pixel having the polarity of (+) in the previous frame becomes (−) in the polarity in the subsequent frame, and the pixel having the polarity of (−) in the previous frame becomes (+) in the polarity in the subsequent frame.

FIG. 10 is a diagram illustrating the potentials of the gradation voltage written into the respective pixels when an image of a vertical stripe of white or black for each dot is displayed on a liquid crystal display panel in the dot inversion driving method.

In the dot inversion method, when the image of the vertical stripe of white or black for each dot is displayed on the liquid crystal display panel, the polarity of a first pixel is plus (+) in a red pixel of DR0 and a blue pixel of DB0, and minus (−) in a green pixel of DG0. The polarity of a second pixel is minus (−) in a red pixel of DR1 and a blue pixel of DB1, and plus (+) in a green pixel of DG1. An effective value of a write voltage in the first pixel (DR0, DG0, DB0) is inclined toward the plus (+) side with respect to the common voltage (VCOM) to be applied to the counter electrode. The effective value of the write voltage in the second pixel (DR1, DG1, DB1) is inclined toward the minus (−) side with respect to the common voltage (VCOM) to be applied to the counter electrode.

For that reason, in a process of writing gradation voltages into the pixels, the potential of the common voltage (VCOM) is distorted by an influence of a parasitic capacitance of the thin-film transistor of each pixel and an influence of the write voltage. As a result, the potential of the common voltage (VCOM), which is originally a fixed voltage, fluctuates as with VCOM′ indicated by a dotted line in FIG. 10. The common voltage (VCOM) across the counter electrode of the first pixel (DR0, DG0, DB0) is totally inclined toward the positive side (potential at the higher potential side with respect to VCOM). As a result, a write voltage (ΔV1) into the red and blue pixels (DR0, DB0) becomes smaller whereas a write voltage (ΔV2) into the green pixel (DG0) becomes larger.

The above-mentioned fluctuation of an effective voltage of the common voltage (VCOM) similarly occurs in a line G1 subsequent to the line G0. The line G0 and the line G1 are reverse in pixel polarity to each other, and therefore opposite in distortion direction to each other. However, the amount of change in the effective voltage (ΔV) is the same.

The above-mentioned fluctuation of the common voltage (VCOM) causes the entire screen of the liquid crystal display panel to appear greenish, thus deteriorating the image quality if the image of vertical stripes of white and black is displayed on the liquid crystal display panel.

The present invention has been made to solve the above problems with the related art, and therefore an object of the present invention is to provide a technology by which, with cancelation of a potential fluctuation of a common voltage, a greenish coloring of a screen displayed on a liquid crystal display panel is reduced to provide a high-quality image in a liquid crystal display device.

The above and other objects and new features of the present invention will become apparent from the description of the present application and the accompanying drawings.

A typical outline of the invention disclosed in the present application will be briefly described as follows.

(1) There is provided a liquid crystal display device including a liquid crystal display panel having plural pixels, plural image lines that input an image voltage to the respective pixels, plural scanning lines that input a scanning voltage to the respective pixels, an image line driver circuit that applies the image voltage to the respective image lines, and a scanning line driver circuit that applies the scanning voltage to the respective scanning lines; a display control circuit that controls and drives the image line driver circuit and the scanning line driver circuit; and a power circuit that applies a drive voltage to the image line driver circuit and the scanning line driver circuit, in which each of the pixels has a pixel electrode and a counter electrode, and when it is assumed that two pixels adjacent to each other on one display line are a pixel A and a pixel B, an image voltage higher than the potential of the counter electrode is applied to the pixel electrode of the pixel A, and an image voltage lower than the potential of the counter electrode is applied to the pixel electrode of the pixel B at a time of writing the image voltage, the liquid crystal display device including:

a detector circuit that detects a specific image pattern that induces a potential fluctuation of a common voltage applied to the counter electrode; and

a VCOM generator circuit that generates the common voltage to be applied to the counter electrode,

wherein the VCOM generator circuit applies the common voltage in which an inverse compensation voltage that compensates the potential fluctuation is superimposed on a reference common voltage to the counter electrode on the basis of a detection result of the detector circuit.

(2) In the feature (1), the detector circuit and the VCOM generator circuit are disposed within the display control circuit.

(3) In the feature (1), the detector circuit is disposed within the display control circuit, and the VCOM generator circuit is disposed within the power circuit.

(4) In any one of the features (1) to (3), the detector circuit includes a variation detector circuit that calculates a luminance variation of display data of the two adjacent pixels among the display data of the respective pixels input from the external to output a pulse when the luminance variation is a first threshold value or higher; a counter that counts the pulse output from the variation detector circuit every one horizontal scanning period; a decoder circuit that outputs a pulse when the number of counts in the counter is a second threshold value or higher; and a control signal generator circuit that outputs a first control signal or a second control signal on the basis of the pulse output from the decoder circuit, and an alternating signal.

(5) In the feature (4), the detector circuit includes a converter circuit that converts image data of red, green, and blue of the respective pixels into luminance data of the respective pixels, which is disposed upstream of the variation detector circuit.

(6) In the feature (4) or (5), the VCOM generator circuit includes a reference power supply that inputs the reference common voltage to a node; a first switch circuit that turns on according to the first control signal, and inputs a low-potential common voltage lower than the reference common voltage to the node; a second switch circuit that turns on according to the second control signal, and inputs a high-potential common voltage higher than the reference common voltage to the node; and a voltage follower circuit that applies the voltage across the node to the counter electrode as the common voltage.

(7) In any one of the features (1) to (6), further including: a power-off control signal generator circuit that outputs the first control signal during a given period when an input power supply input from the external turns off, wherein the VCOM generator circuit applies the low-potential common voltage to the counter electrode during the given period when the input power supply is off, on the basis of the first control signal output from the power-off control signal generator circuit.

(8) In the feature (7), the power-off control signal generator circuit outputs the first control signal during the given period, on the basis of an SELFM signal that turns off when a voltage level of the input power supply is a given voltage level or lower.

(9) There is provided a liquid crystal display device including a liquid crystal display panel having plural pixels, plural image lines that input an image voltage to the respective pixels, plural scanning lines that input a scanning voltage to the respective pixels, an image line driver circuit that applies the image voltage to the respective image lines, and a scanning line driver circuit that applies the scanning voltage to the respective scanning lines; a display control circuit that controls and drives the image line driver circuit and the scanning line driver circuit; and a power circuit that applies a drive voltage to the image line driver circuit and the scanning line driver circuit, the liquid crystal display device including: a power-off control signal generator circuit that outputs a control signal during a given period when an input power supply input from the external turns off; and a VCOM generator circuit that generates a common voltage to be applied to a counter electrode, wherein the VCOM generator circuit applies a low-potential common voltage lower than a reference common voltage to the counter electrode during the given period when the input power supply turns off, on the basis of the control signal output from the power-off control signal generator circuit.

(10) In the feature (9), the power-off control signal generator circuit outputs the control signal for a given period, on the basis of an SELFM signal that turns off when a voltage level of the input power supply is a given voltage level or lower.

(11) In the feature (9) or (10), the VCOM generator circuit includes a reference power supply that inputs the reference common voltage to a node; a switch circuit that turns on according to the control signal, and inputs the low-potential common voltage lower than the reference common voltage to the node; and a voltage follower circuit that applies the voltage across the node to the counter electrode as the common voltage.

The advantages obtained by the typical configuration of the invention disclosed in the present application will be described in brief as follows.

According to the liquid crystal display device of the present invention, with cancelation of the potential fluctuation of the common voltage, the greenish coloring of a screen displayed on the liquid crystal display panel is reduced to provide a high-quality image.

### BRIEF DESCRIPTION OF THE DRAWINGS

In the accompanying drawings:

FIG. 1 is a block diagram illustrating an outline configuration of a liquid crystal display device as a precondition to the present invention;

FIG. 2 is a diagram illustrating an exemplary equivalent circuit of a liquid crystal display panel illustrated in FIG. 1;

FIG. 3 is a diagram illustrating voltage waveforms of an alternating signal that is a control signal of a drain driver, and a common voltage to be applied to a counter electrode in the present invention;

FIG. 4 is a block diagram illustrating a detector circuit that detects image data (image data for displaying a killer pattern) inducing a potential fluctuation of a common voltage to generate a control signal for generating an inverse compensation common voltage in a liquid crystal display device according to an embodiment of the present invention;

FIG. 5 is a diagram illustrating a VCOM generator circuit that generates a common voltage to be applied to a counter electrode in the liquid crystal display device according to the embodiment of the present invention;

FIG. 6 is a diagram illustrating a voltage waveform of a common voltage to be applied to the counter electrode when displaying a vertical stripe image of white/black, which is a killer pattern, on a liquid crystal display panel in the liquid crystal display device according to the embodiment of the present invention;

FIG. 7 is a diagram illustrating a power sequence at the time of power-off in a liquid crystal display device according to a second embodiment of the present invention;

FIG. 8 is a diagram illustrating a power-off control signal generator circuit in the liquid crystal display device according to the second embodiment of the present invention;

FIG. 9 is a diagram illustrating a pixel drive polarity in a dot inversion method of the liquid crystal display device; and

FIG. 10 is a diagram illustrating a potential of a gradation voltage written into the respective pixels when displaying an image of a vertical stripe of white/black every one dot on a liquid crystal display panel through the dot inversion method.

### DETAILED DESCRIPTION OF THE INVENTION

Hereinafter, embodiments of the present invention will be described in detail with reference to the accompanying drawings.

In all of the drawings for illustrating the embodiments, parts having the same functions are denoted by identical reference numerals, and their repetitive description will be omitted. Also, the following embodiments do not limit the interpretation of claims of the present invention.

### [Configuration of Liquid Crystal Display Device According to the Present Invention]

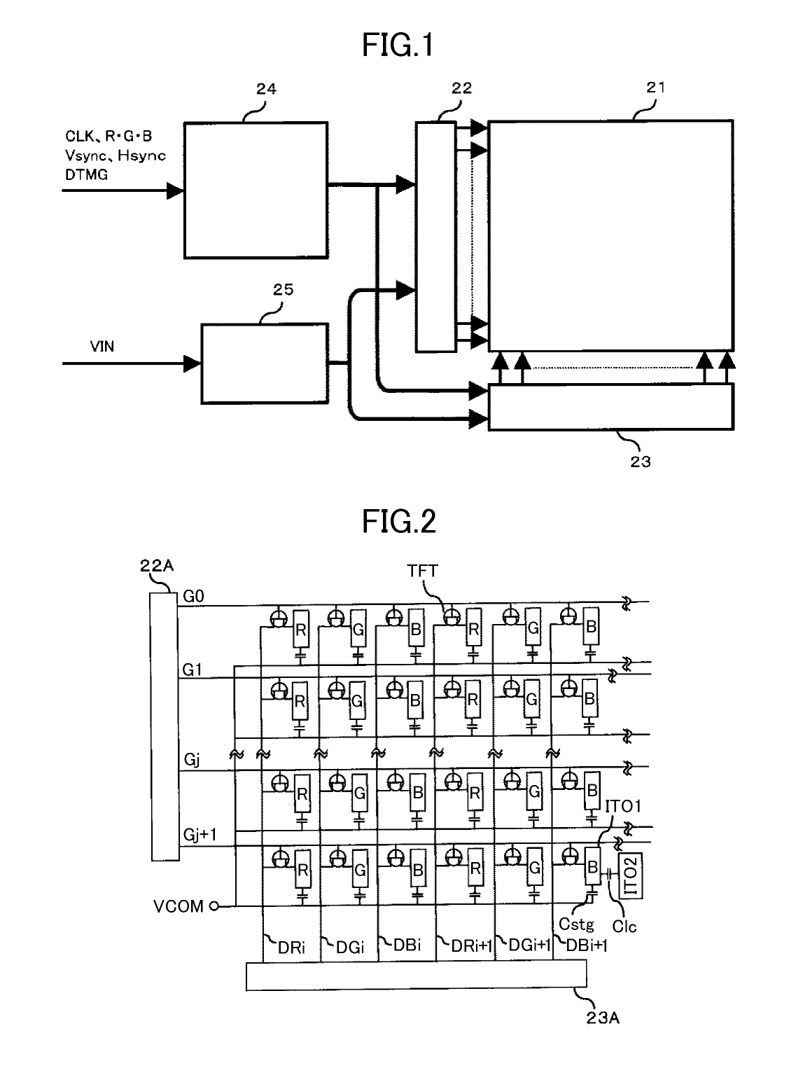

FIG. 1 is a block diagram illustrating an outline configuration of a liquid crystal display device according to an embodiment of the present invention.

The liquid crystal display device according to the embodiment includes a liquid crystal display panel 21, a drain driver part 23, a gate driver part 22, a display control circuit 24, and a power circuit 25.

The drain driver part 23 includes plural drain drivers, and the plural drain drivers are disposed in a periphery of the liquid crystal display panel 21. For example, the plural drain drivers are mounted on a periphery of one side of a first substrate (for example, glass substrate) out of a pair of substrates in the liquid crystal display panel 21 by a COG (chip on glass) method. Alternatively, the plural drain drivers are mounted on a flexible circuit board arranged in a periphery of one side of the first substrate of the liquid crystal display panel 21 by a COF (chip on film) method.

Likewise, the gate driver part 22 includes plural gate drivers, and the plural gate drivers are disposed in a periphery of the liquid crystal display panel 21. For example, the plural gate drivers are mounted on a periphery of one side (another side except for the one side on which the drain drivers are mounted) of the first substrate (for example, glass substrate) out of the pair of substrates in the liquid crystal display panel 21 by a COG method. Alternatively, the plural gate drivers are mounted on the flexible circuit board arranged in a periphery of one side (another side except for the one side on which the drain drivers are mounted) of the first substrate (of the liquid crystal display panel 21 by a COF method.

The display control circuit 24 and the power circuit 25 are respectively mounted on a circuit board arranged in a periphery (for example, a back side surface of the liquid crystal display device) of the liquid crystal display panel 21.

The display control circuit 24 receives, from a display signal source such as a personal computer or a television receiver circuit, display data (R, G, B), and display control signals such as a clock (CLK), a vertical synchronous signal (Vsync), a horizontal synchronous signal (Hsync), and a display timing signal (DTMG).

The display control circuit 24 conducts timing adjustment suitable for display of the liquid crystal display panel 21 such as the conversion of a voltage corresponding to a display signal into a voltage having an AC waveform, converts the display data into display data of a display format, and inputs the display data together with the synchronous signal (clock signal) to the respective drain drivers of the drain driver part 23 and the respective gate drivers of the gate driver part 22.

Each of the gate drivers sequentially applies a selection scanning voltage to the corresponding scanning line (also called “gate line”; G) under the control of the display control circuit 24, and each of the drain drivers applies a gradation voltage (also called “image voltage”) to the corresponding image line (also called “drain line” or “source line”; D) to display an image. The power circuit 25 generates various voltages required for the liquid crystal display device on the basis of an input voltage (VIN).

FIG. 2 is a diagram illustrating an exemplary equivalent circuit of the liquid crystal display panel 21 illustrated in FIG. 1.

As illustrated in FIG. 2, the liquid crystal display panel 21 includes plural sub-pixels, and the respective sub-pixels are disposed in areas surrounded by the image lines (D) and the scanning lines (G).

Each of the sub-pixels includes a thin-film transistor (TFT). In the thin film transistor (TFT), a first electrode (either one of a drain electrode and a source electrode) of the thin-film transistor (TFT) is connected to the corresponding image line (D), and a second electrode (the other of the source electrode and the drain electrode) of the thin-film transistor (TFT) is connected to a pixel electrode (1101). Also, a gate electrode of the thin-film transistor (TFT) is connected to the corresponding scanning line (G).

Referring to FIG. 2, Clc is a liquid crystal capacity equivalently representative of a liquid crystal layer disposed between the pixel electrode (1101) and a counter electrode (1102), and Cstg is a retention capacity formed between the pixel electrode (1101) and the counter electrode (1102).

In the liquid crystal display panel 21 illustrated in FIG. 2, the first electrodes of the thin-film transistors (TFT) of the respective sub-pixels arranged in a column direction are connected to the corresponding image lines (D) respectively, and each image line (D) is connected to a drain driver 23A that applies a gradation voltage corresponding to the display data to the sub-pixels arranged in the column direction.

The gate electrodes of the thin-film transistors (TFT) of the respective sub-pixels arranged in a row direction are connected to the corresponding scanning lines (G) respectively, and each scanning line (G) is connected to a gate driver 22A that applies a scanning voltage (positive or negative bias voltage) to the gate electrode of the corresponding thin-film transistor (TFT) for one horizontal scanning time. Although FIG. 2 illustrates only one drain driver 23A and only one gate driver 22A, two or more drain drivers and gate drivers may be actually arranged.

In displaying an image on the liquid crystal display panel 21, the gate driver 22A sequentially selects the scanning lines (G0, G1, . . . Gj, Gj+1) downward (in the stated order of G0, G1, . . . ). On the other hand, during a period in which a certain scanning line (G) is selected, the drain driver 23A applies the gradation voltage corresponding to the display data to the image line (D).

The voltage applied to the image line (D) is applied to the pixel electrode (ITO1) through the thin-film transistor (TFT), and electric charge is finally accumulated in the retention capacity (Cstg) and the liquid crystal capacity (Clc). Liquid crystal molecules are controlled to display an image.

Note that in the above description of FIGS. 9 and 10, it is assumed that the liquid crystal display device operates in a so-called normally black-displaying mode in which the luminance becomes higher as a potential difference between the gradation voltage to be applied to each pixel and a common voltage (VCOM) is larger.

In the liquid crystal display panel 21, the first substrate on which the pixel electrodes (ITO1) and the thin-film transistors (TFT) are formed, and a second substrate on which color filters are formed are superimposed on each other with a given gap. Both of those substrates are bonded together by a sealant disposed in the vicinity of a periphery of those substrates in a frame shape. Liquid crystal is encapsulated and sealed inside of the sealant between both of those substrates from a liquid crystal inclusion inlet disposed in a part of the sealant. Further, a polarization plate is stuck onto the outside of each substrate.

The counter electrode (ITO2) is disposed on the second substrate side in the case of the liquid crystal display panel of TN or VA. In the case of the liquid crystal display panel of IPS, the counter electrode (ITO2) is disposed on the first substrate side.

Also, the present invention is irrelevant to the internal structure of the liquid crystal panel, and therefore a detailed description of the internal structure of the liquid crystal panel will be omitted. Further, the present invention is applicable to the liquid crystal panel with any structure.

### [Features of the Invention]

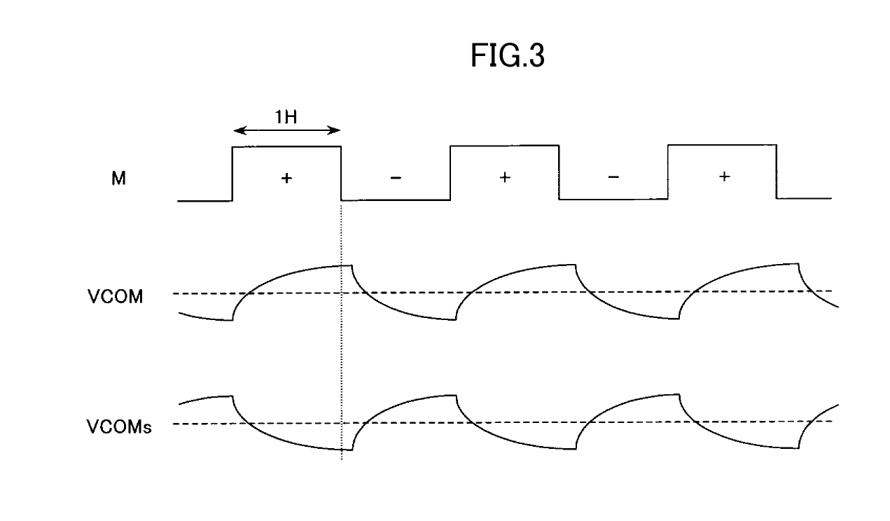

FIG. 3 is a diagram illustrating voltage waveforms of an alternating signal (M) that is the control signal of the drain driver 23A, and the common voltage (VCOM) to be applied to the counter electrode (ITO2) in the present invention.

As illustrated in FIG. 3, the alternating signal (M) determines an alternating polarity when writing the gradation voltage into each pixel. The alternating signal (M) repeats high/low every one horizontal scanning period (1H). In a high (hereinafter referred to simply as “H”) level period, for example, the alternating signal (M) writes a gradation voltage (indicated by + in FIG. 3) higher than the voltage of VCOM into odd pixels, and writes a gradation voltage (indicated by − in FIG. 3) lower than the voltage of VCOM into even pixels. In a low (hereinafter referred to simply as “L”) level period, for example, the alternating signal (M) writes the gradation voltage (indicated by − in FIG. 3) lower than the voltage of VCOM into the odd pixels, and writes the gradation voltage (indicated by + in FIG. 3) higher than the voltage of VCOM into the even pixels.

When a vertical stripe image of white/black with every one pixel is displayed on the liquid crystal display panel 21, the potential of the common voltage (VCOM) across the counter electrode (1102) repeats vertical fluctuation in conformity with the polarity of the alternating signal (M) due to the above-mentioned distortion of the voltage of VCOM, thereby deteriorating the image quality.

In the present invention, a common voltage (VCOMs; hereinafter referred to as “inverse compensation common voltage”) in which an inverse compensation voltage that compensates (or cancels) the potential fluctuation of the counter electrode (1102) is superimposed on a reference common voltage is produced by the display control circuit 24. Then, the common voltage is applied to the counter electrode (1102) within the liquid crystal display panel 21 to cancel the potential fluctuation of the counter electrode (1102). As a result, the deterioration of the image quality in which a display screen of the liquid crystal display panel 21 is greened is reduced, thereby enabling the high-quality image to be provided.

### First Embodiment

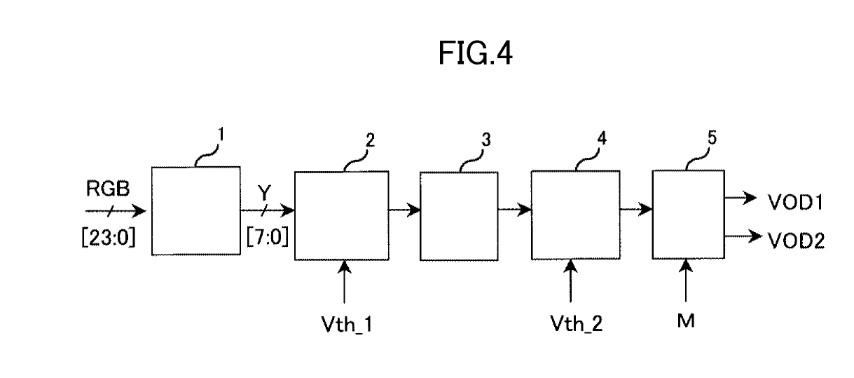

FIG. 4 is a block diagram illustrating a detector circuit that detects image data (image data for displaying a killer pattern) inducing a potential fluctuation of the common voltage (VCOM) to generate a control signal for generating the inverse compensation common voltage (VCOMs) in a liquid crystal display device according to a first embodiment of the present invention.

The detector circuit illustrated in FIG. 4 is disposed within the display control circuit 24. The detector circuit illustrated in FIG. 4 includes a converter circuit 1, a variation detector circuit 2, an 8-bit counter 3, a decoder circuit 4, and a VOD generator circuit 5.

The converter circuit 1 converts the image data (8 bits×3=24 bits) for R, G, and B each having 8 bits which is input from the external into luminance data (Y) [7:0] of 8 bits on the basis of the following Expression (1).

Y=0.299×R+0.587×G+0.1140×B (1)

The variation detector circuit 2 calculates a luminance variation ΔV between two adjacent pixels according to the luminance data (Y) converted by the converter circuit 1, and outputs “1” when the luminance variation ΔV is a given threshold value Vth_1 or higher.

The 8-bit counter 3 counts the number of “1” output from the variation detector circuit 2 every one horizontal scanning period (1 H). The decoder circuit 4 outputs “1” when the count value of the counter 3 is a given threshold value Vth_2 or higher.

The VOD generator circuit 5 generates control signals (inverse compensation enable control signals; VOD1, VOD2) for determining the inverse compensation voltage to be applied to the counter electrode (ITO2) according to “0” or “1” of the alternating signal (M) of the liquid crystal display device when the output of the decoder circuit 4 is “1”.

For example, it is assumed that the image data of the vertical stripe image of white with 255 gradations and black with 0 gradations, which is a killer pattern, is input to the liquid crystal display device having a horizontal resolution 800 pixels through the dot inversion method, and Vth_1=200 gradations and Vth_2=300 are set as the threshold values.

In this case, first in the converter circuit 1, the image data for R, G, and B each having 8 bits is converted into the luminance data (Y) of 8 bits. In the variation detector circuit 2, the luminance variation ΔV of white/black (=255−0) is calculated. Because the luminance variation ΔV is 200 or higher of the threshold value Vth_1, 400 (=800/2) pulses (“1”) are output to the downstream counter 3.

The pulse is counted by the 8-bit counter 3 every one horizontal scanning period (1 H). Since the count value exceeds 300 of the threshold value Vth_2, the decoder circuit 4 outputs the pulse (“1”) to the VOD generator circuit 5, and the VOD generator circuit 5 generates the control signal of VOD1 or VOD2 according to the polarity of the alternating signal (M). In this example, the VOD generator circuit 5 outputs the control signal of VOD1 when the alternating signal (M) is “1”, and outputs the control signal of VOD2 when the alternating signal (M) is “0”. The VOD generator circuit 5 then sends the control signal to a VCOM generator circuit that will be described later, and generates the inverse compensation common voltage (VCOMs).

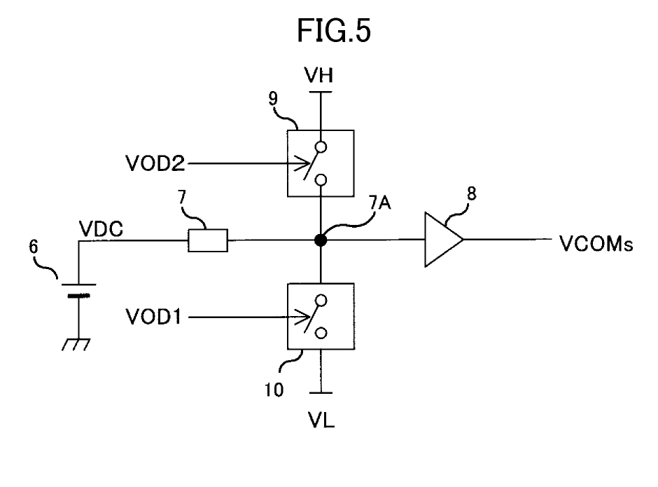

FIG. 5 is a diagram illustrating the VCOM generator circuit that generates the common voltage (VCOM) to be applied to the counter electrode (1102) in the liquid crystal display device according to the embodiment of the present invention. The VCOM generator circuit is disposed within the display control circuit 24 or the power circuit 25.

The VCOM generator circuit illustrated in FIG. 5 includes a power supply part 6 that creates a reference DC voltage (VDC) of the common voltage (VCOM), a resistor element 7 for current limit, a gain (gain 1) voltage feedback amplifier circuit (so-called voltage follower circuit) 8 that buffers a voltage across a node 7A downstream of the resistor element 7 and applies the voltage to the counter electrode (1102) within the liquid crystal display panel 21, a switch circuit 10 that turns on/off according to the control signal of VOD1, and a switch circuit 9 that turns on/off according to the control signal of VOD2.

In this case, it is assuming that the reference DC voltage (VDC) is set to 6 V (VDC=6V), voltage of VH is set to 9 V (VH=9 V), voltage of VL is set to 3 V (VL=3 V), and voltage drop in the resistor element 7 and the voltage feedback amplifier circuit 8 during the operation is slight and therefore ignored. When both of the control signal of VOD1 and the control signal of VOD2 are “0”, both of the switch circuit 9 and the switch circuit 10 turn off, and a potential 6 V equal to the reference DC voltage (VDC) is output as the inverse compensation common voltage (VCOMs).

In the case where the inverse compensation voltage is superimposed on the common voltage, for example, when the control signal of VOD1 is “1” (VOD1=“1”), and the control signal of VOD2 is “0” (VOD2=“0”), the switch circuit 10 turns on, and the switch circuit 9 turns off. Therefore, 3 V that is the voltage of VL is output as the inverse compensation common voltage (VCOMs). Contrary, when the control signal of VOD1 is “0” (VOD1=“0”), and the control signal of VOD2 is “1” (VOD2=“1”), the switch circuit 9 turns on, and the switch circuit 10 turns off. Therefore, 9 V that is the voltage of VH is output as the inverse compensation common voltage (VCOMs).

The inverse compensation voltage is superimposed on the common voltage on the basis of the control signals (VOD1, VOD2) and the alternating signal (M) detected by the detector circuit illustrated in FIG. 4 in synchronism with writing of the gradation voltage based on the image data for one line which is detected by the detector circuit illustrated in FIG. 4 into the respective pixels.

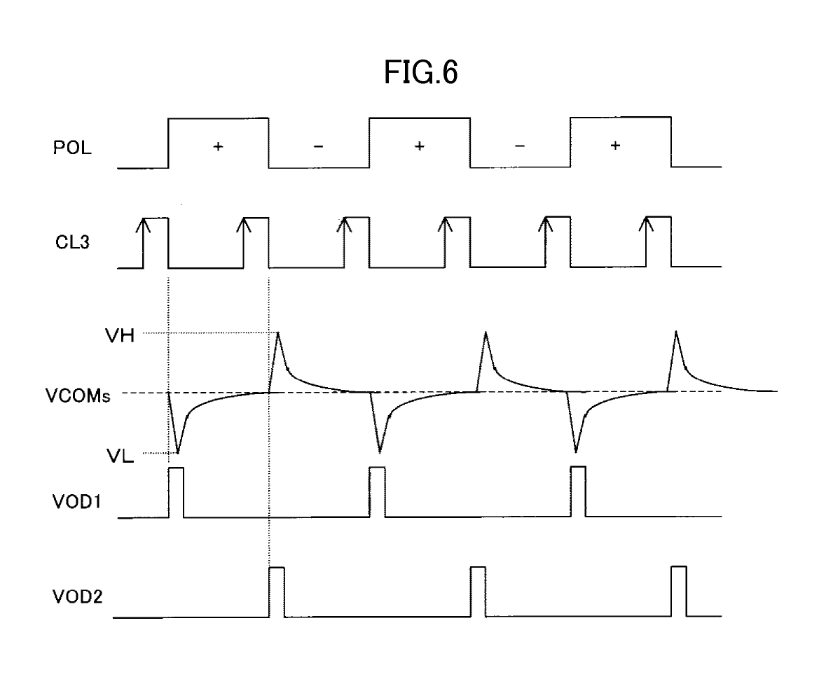

FIG. 6 is a diagram illustrating a voltage waveform of the common voltage to be applied to the counter electrode (ITO2) when displaying the vertical stripe image of white/black, which is a killer pattern, on the liquid crystal display panel in the liquid crystal display device according to this embodiment of the present invention. Referring to FIG. 6, CL3 is a control signal of the gate driver 22A, and represents a signal for controlling the on/off operation of writing the voltage into the corresponding pixels in one horizontal scanning period every time the signal of CL3 rises. In a period where the control signal of VOD1 is “1”, the inverse compensation common voltage (VCOMs) decreases down to the voltage of VL which is 3V, and in a period where the control signal of VOD2 is “1”, the inverse compensation common voltage (VCOMs) increases up to the voltage of VH which is 9V. In other cases, the inverse compensation common voltage (VCOMs) is converged to 6 V of the reference DC voltage (VDC). The pulse widths of the control signals of VOD1 and VOD2 are required to be appropriately adjusted according to a potential difference between the common voltage and a maximum gradation voltage, the potential fluctuation of the common voltage, a type of liquid crystal, and the like. As described above, when the alternating signal (M) is “1” and positive, in the common voltage in the killer pattern (vertical stripe image of white/black) display, the voltage across the counter electrode (ITO2) within the liquid crystal display panel is pulled up to a potential (VCOM′) higher than 6 V of a center voltage due to the inclination of the write voltage into the pixels. However, in FIG. 6, since the control signal of VOD1 is set to “1”, in rising timing of the signal of CL3 where the inverse compensation common voltage (VCOMs) is temporarily decreased down to 3 V as the inverse compensation voltage to the voltage increase to complete the pixel write, the voltage across the counter electrode (ITO2) within the liquid crystal display panel 21 becomes about 6 V of the center voltage.

Also, as described above, when the alternating signal (M) is “0” and negative, in the common voltage in the killer pattern display, the voltage across the counter electrode (ITO2) within the liquid crystal display panel is pulled down to a potential lower than 6 V of the center voltage due to the inclination of the write voltage into the pixels. However, in FIG. 6, since the control signal of VOD2 is set to “1”, in rising timing of the signal of CL3 where the inverse compensation common voltage (VCOMs) is temporarily increased up to 9 V as the inverse compensation voltage to the voltage drop to complete the pixel write, the voltage across the counter electrode (1102) within the liquid crystal display panel 21 becomes about 6 V of the center voltage. Accordingly, an effective write voltage (ΔV1) into the sub-pixels of red (R) and blue (B) illustrated in FIG. 10 becomes substantially equal to an effective write voltage (ΔV2) into the sub-pixels of green (G), and the deterioration of the image quality in which the entire screen is greened can be reduced.

In the above description, the killer pattern displayed on the liquid crystal display panel is the vertical stripe image of white/black. However, the present invention can be applied to a case in which the killer pattern displayed on the liquid crystal display panel is a vertical stripe image of black/white. However, in this case, there is a need for the VOD generator circuit 5 of FIG. 4 to output the control signal of VOD2 when the alternating signal (M) is “1”, output the control signal of VOD1 when the alternating signal (M) is “0”, and send the control signal to the VCOM generator circuit to generate the inverse compensation common voltage (VCOMs).

Also, in the above description, as a method of driving the liquid crystal display device, the dot inversion method is applied. However, the present invention is not limited to this configuration, but the present invention can be also applied to a case in which an n-line (for example, 2 lines) inversion method is applied as the method of driving the liquid crystal display device.

### Second Embodiment

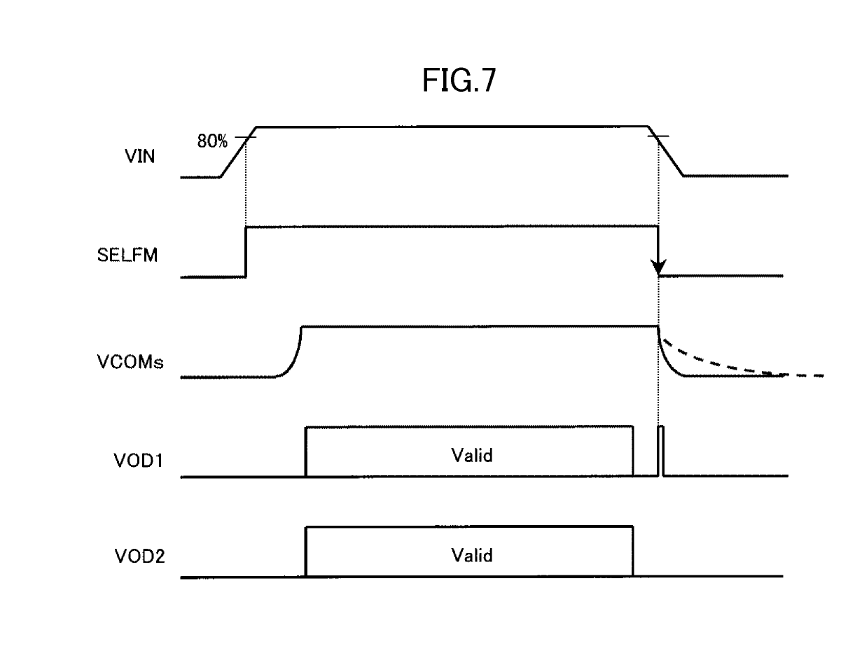

FIG. 7 is a diagram illustrating a power sequence at the time of power-off in a liquid crystal display device according to a second embodiment of the present invention. Referring to FIG. 7, VIN is an input power supply (for example, a DC power supply of +12 V) that is input to the liquid crystal display device from the external. An SELFM signal represents a signal for detecting a voltage level of the input power supply (VIN), and the SELFM signal becomes “1” when the voltage level of the input power supply (VIN) reaches 80% or more of a specified value, and “0” when the voltage level is lower than 80% of the specified value.

In the liquid crystal display device, when the input power supply (VIN) input from the external turns off, the common voltage (VCOM) is exponentially decreased as discharge of electric charge from an equivalent capacity (capacitor) parasitic in a common voltage line of the liquid crystal display panel, as indicated by a dotted line in FIG. 7. Even when the input power supply (VIN) becomes 0 V, the common voltage remains in the liquid crystal display panel as residual electric charge. As a result, apparently, in a state where the liquid crystal display panel is inoperative, a DC voltage is applied to the liquid crystal layer. This causes the deterioration of liquid crystal.

Accordingly, there is a need that electric charge accumulated in the common voltage line of the liquid crystal display panel 21 is discharged as soon as the input power supply (VIN) turns off, and the voltage across the counter electrode (ITO2) is quickly reduced to 0 V.

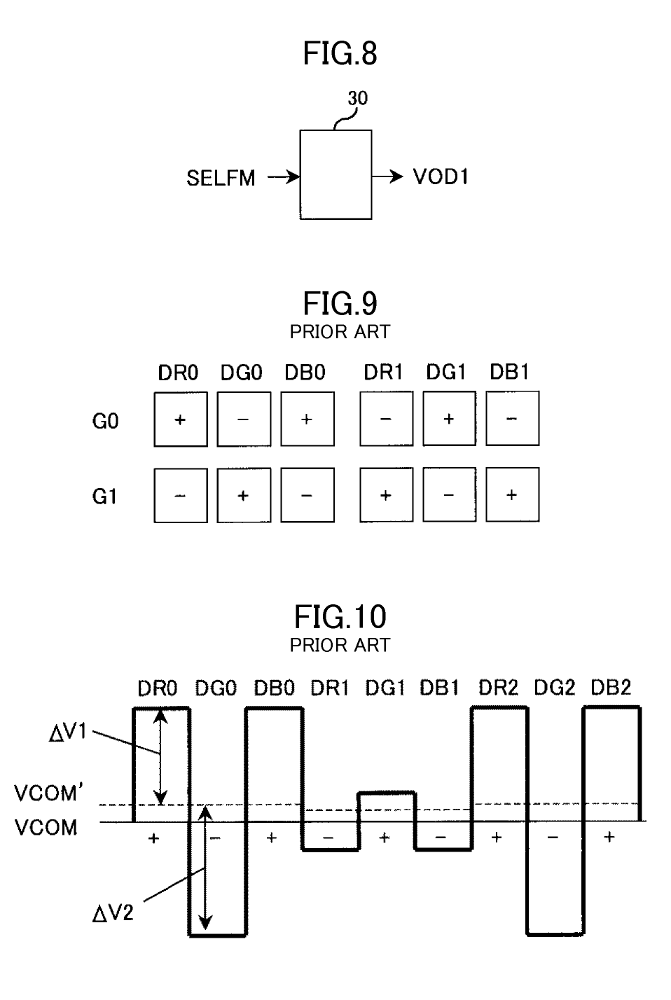

FIG. 8 is a diagram illustrating a power-off control signal generator circuit in the liquid crystal display device according to the second embodiment of the present invention.

In this embodiment, with the provision of a power-off control signal generator circuit 30 to which the SELFM signal is input, the control signal of VOD1 is set to “1” (VOD1=“1”) in a falling edge of the SELFM signal, the voltage feedback amplifier circuit 8 of the VCOM generator circuit illustrated in FIG. 5 operates for a period of several μs, and the common voltage to be applied to the counter electrode (1102) is decreased down to the voltage of VL which is 3 V. Thereafter, the common voltage is set to 0 V in natural discharge.

In this embodiment, it is needless to say that even when the input power supply (VIN) becomes 0 V, the voltage of VL and the supply voltage of the power-off control signal generator circuit 30 and the voltage feedback amplifier circuit 8 is applied for a while.

Also, this embodiment and the above-mentioned first embodiment may be combined together, or this embodiment may be implemented alone. When this embodiment is implemented alone, in the VCOM generator circuit illustrated in FIG. 5, the switch circuit 9 is not required. Further, the power-off control signal generator circuit 30 according to this embodiment can be configured by, for example, a monostable flip-flop circuit.

As described above, in this embodiment, when the input power supply (VIN) turns off, the falling time of the common voltage of the counter electrode (1102) can be quickened. Therefore, the residual electric charge causing the deterioration of liquid crystal is reduced, as a result of which the lifetime and reliability of the liquid crystal display device can be improved.

The present invention made by the present inventors has been described in detail with reference to the embodiments. However, the present invention is not limited to the above embodiments, and can be variously changed without departing from the subject matter of the invention.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a liquid crystal display panel comprising:
a plurality of pixels including a pixel A and a pixel B adjacent to each other on one display line, each of the plurality of pixels having a pixel electrode and a counter electrode;
a plurality of image lines that input an image voltage to the respective pixels;
a plurality of scanning lines that input a scanning voltage to the respective pixels;
an image line driver circuit that applies the image voltage to the respective image lines; and
a scanning line driver circuit that applies the scanning voltage to the respective scanning lines;
a display control circuit that controls and drives the image line driver circuit and the scanning line driver circuit;
a power circuit that applies a drive voltage to the image line driver circuit and the scanning line driver circuit;
a detector circuit that detects a specific image pattern that induces a potential fluctuation of a common voltage applied to the counter electrode; and
a VCOM generator circuit that generates the common voltage to be applied to the counter electrode,
wherein at a time of writing the image voltage, when an image voltage higher than the potential of the counter electrode is applied to the pixel electrode of the pixel A, an image voltage lower than the potential of the counter electrode is applied to the pixel electrode of the pixel B, and
wherein the VCOM generator circuit applies the common voltage in which an inverse compensation voltage that compensates the potential fluctuation is superimposed on a reference common voltage to the counter electrode on the basis of a detection result of the detector circuit.

2. The liquid crystal display device according to claim 1,
wherein the detector circuit and the VCOM generator circuit are disposed within the display control circuit.

3. The liquid crystal display device according to claim 1,
wherein the detector circuit is disposed within the display control circuit, and
wherein the VCOM generator circuit is disposed within the power circuit.

4. The liquid crystal display device according to claim 1,
wherein the detector circuit comprises:
a variation detector circuit that calculates a luminance variation of display data of the two adjacent pixels among the display data of the respective pixels input from the external to output a pulse when the luminance variation is a first threshold value or higher;
a counter that counts the pulse output from the variation detector circuit every one horizontal scanning period;
a decoder circuit that outputs a pulse when the number of counts in the counter is a second threshold value or higher; and
a control signal generator circuit that outputs a first control signal or a second control signal on the basis of the pulse output from the decoder circuit, and an alternating signal.

5. The liquid crystal display device according to claim 4,
wherein the detector circuit further comprises: a converter circuit that converts image data of red, green, and blue of the respective pixels into luminance data of the respective pixels, which is disposed upstream of the variation detector circuit.

6. The liquid crystal display device according to claim 4,
wherein the VCOM generator circuit comprises:
a reference power supply that inputs the reference common voltage to a node;
a first switch circuit that turns on according to the first control signal, and inputs a low-potential common voltage lower than the reference common voltage to the node;
a second switch circuit that turns on according to the second control signal, and inputs a high-potential common voltage higher than the reference common voltage to the node; and
a voltage follower circuit that applies the voltage across the node to the counter electrode as the common voltage.

7. The liquid crystal display device according to claim 4, further comprising: a power-off control signal generator circuit that outputs the first control signal during a given period when an input power supply input from the external turns off,
wherein the VCOM generator circuit applies the low-potential common voltage to the counter electrode during the given period when the input power supply is off, on the basis of the first control signal output from the power-off control signal generator circuit.

8. The liquid crystal display device according to claim 7,
wherein the power-off control signal generator circuit outputs the first control signal during the given period, on the basis of an SELFM signal that turns off when a voltage level of the input power supply is a given voltage level or lower.

9. A liquid crystal display device, comprising:
a liquid crystal display panel comprising:
a plurality of pixels;
a plurality of image lines that input an image voltage to the respective pixels;
a plurality of scanning lines that input a scanning voltage to the respective pixels;
an image line driver circuit that applies the image voltage to the respective image lines; and
a scanning line driver circuit that applies the scanning voltage to the respective scanning lines;
a display control circuit that controls and drives the image line driver circuit and the scanning line driver circuit;
a power circuit that applies a drive voltage to the image line driver circuit and the scanning line driver circuit;
a power-off control signal generator circuit that outputs a control signal during a given period when an input power supply input from the external turns off; and
a VCOM generator circuit that generates a common voltage to be applied to a counter electrode,
wherein the VCOM generator circuit applies a low-potential common voltage lower than a reference common voltage to the counter electrode during the given period when the input power supply turns off, on the basis of the control signal output from the power-off control signal generator circuit.

10. The liquid crystal display device according to claim 9,
wherein the power-off control signal generator circuit outputs the control signal for a given period, on the basis of an SELFM signal that turns off when a voltage level of the input power supply is a given voltage level or lower.

11. The liquid crystal display device according to claim 9,
wherein the VCOM generator circuit comprises:
a reference power supply that inputs the reference common voltage to a node;
a switch circuit that turns on according to the control signal, and inputs the low-potential common voltage lower than the reference common voltage to the node; and
a voltage follower circuit that applies the voltage across the node to the counter electrode as the common voltage.
